(19) United States
(12) Patent Application Publication
(10) Pub. No.: US 2009/0219130 A1
(43) Pub. Date: Sep. 3, 2009

(54) PORTABLE ELECTRONIC DEVICE AND RECOVERY METHOD THEREFOR

(75) Inventors: Lung Dai, Tu-Cheng (TW); Wang-Chang Duan, Shenzhen City (CN); Bang-Sheng Zuo, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/344,455

(22) Filed: Dec. 26, 2008

(30) Foreign Application Priority Data
Feb. 28, 2008 (CN) 200810300421.0

(51) Int. Cl. G05B 23/02

(52) U.S. Cl. 340/3.1

(57) ABSTRACT

A portable electronic device includes an airbag, a gas-injection apparatus connecting with the airbag, a housing, a liquid detecting apparatus and a control apparatus. The gas-injection apparatus connected with the airbag is used for injecting gas into the airbag so that the airbag is in an inflated state. The housing with a receiving space is used for accommodating the airbag in a deflated state, and the airbag is capable of expanding out of the housing when changing from the deflated state to the inflated state. The liquid detecting apparatus is configured for detecting when the portable electronic device contacts liquid and generating a detecting signal. The control apparatus is configured for controlling the gas-injection apparatus to inject gas into the airbag upon receiving the detecting signal.

### BACKGROUND

1. Technical Field

Embodiments of the present disclosure generally relate to a portable electronic device and a recovery method for the portable electronic device.

2. Description of Related Art

Portable electronic devices are almost always lost when inadvertently dropped in a body of liquid.

Therefore, improved portable electronic devices and recovery methods for the portable electronic devices are needed to address the aforementioned deficiencies and inadequacies.

### BRIEF DESCRIPTION OF THE DRAWINGS

FIG. 1 is a pictorial representation of a portable electronic device in accordance with a first exemplary embodiment of the present invention.

FIG. 2 is a block diagram of the portable electronic device in FIG. 1.

FIG. 3 is a block diagram of a portable electronic device in accordance with a second exemplary embodiment of the present invention.

FIG. 4 is a flowchart of a recovery method for a portable electronic device in accordance with an exemplary embodiment of the present invention.

FIG. 5 is a flowchart of details of a block S806 of FIG. 4, in accordance with one exemplary embodiment.

FIG. 6 is a flowchart of details of the block S806 of FIG. 4, in accordance with another exemplary embodiment.

### DETAILED DESCRIPTION OF EXEMPLARY EMBODIMENTS

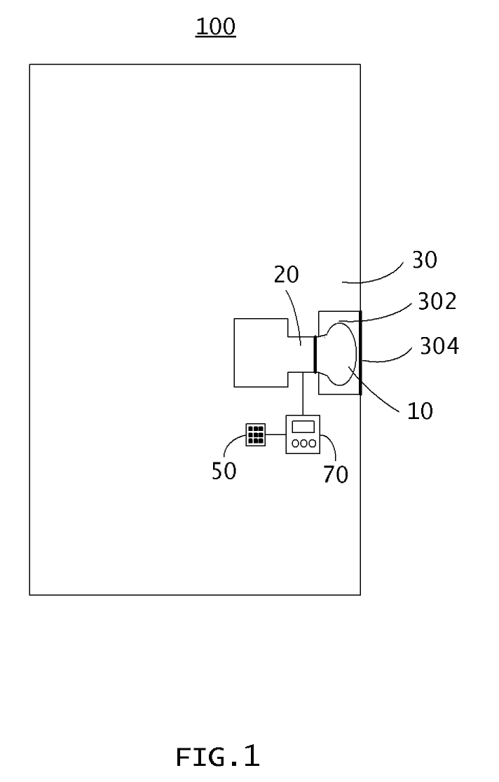

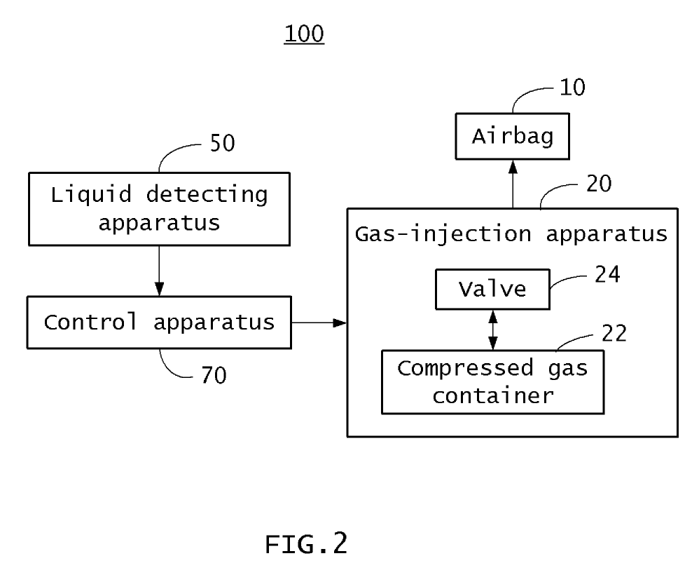

Referring to FIGS. 1 and 2, a portable electronic device 100 includes an airbag 10, a gas-injection apparatus 20, a housing 30, a liquid detecting apparatus 50, and a control apparatus 70.

The airbag 10 has two states; a deflated state, and an inflated state. The airbag 10 is in the deflated state when the portable electronic device 100 is not in contact with liquid. The airbag 10 is filled with gas to be in the inflated state when the portable electronic device 100 is in contact with liquid, so that the airbag 10 can allow the portable electronic device 100 to float and facilitate recovery of the portable electronic device 100.

The gas-injection apparatus 20 connected with the airbag 10 is used for injecting gas into the airbag 10, thereby inflating the airbag 10 when the portable electronic device 100 is in contact with liquid.

The housing 30 defines a receiving space 302 for accommodating the airbag 10 in the deflated state. The housing 30 includes a lid 304 for covering the receiving space 302. The airbag 10 is configured to break out of the lid 304 when changing from the deflated state to the inflated state.

The liquid detecting apparatus 50 is used for detecting whether the portable electronic device 100 is in contact with liquid, and generating a detecting signal when the portable electronic device 100 is in contact with liquid. The liquid detecting apparatus 50 may be a liquid sensor.

The control apparatus 70 is connected between the liquid detecting apparatus 50 and the gas-injection apparatus 20. The control apparatus 70 is used for receiving the detecting signal from the liquid detecting apparatus 50, and controlling the gas-injection apparatus 20 to inject gas into the airbag 10 upon receiving the detecting signal. Thus the airbag 10 becomes filled with air and changes to the inflated state, thereby enabling the portable electronic device 100 to float. In this way, the airbag 10 helps protect the portable electronic device 100 from liquid (e.g. water) damage, and enables the portable electronic device 100 to be conveniently recovered.

In one embodiment, the gas-injection apparatus 20 includes a compressed gas container 22, and a valve 24 for opening or closing the compressed gas container 22. The valve 24 has two states; an open state, and a closed state. When the control apparatus 70 receives the detecting signal, the control apparatus 70 opens the valve 24, so that gas in the compressed gas container 22 is injected into the airbag 10.

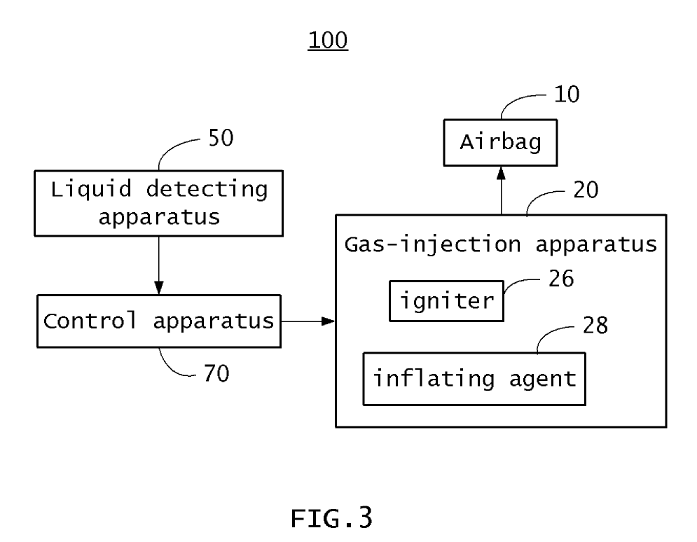

Referring to FIG. 3, in another embodiment, the gas-injection apparatus 20 includes an igniter 26 and an inflating agent 28. The inflating agent 28 has two states; a compressed state, and an expanded state. The compressed state may be in a liquid form or a solid form, and the expanded state is in a gaseous form. The inflating agent 28 changes from the compressed state to the expanded state when ignited. When the control apparatus 70 receives the detecting signal, the control apparatus 70 controls the igniter 26 to ignite. As a result, the inflating agent 28 changes from the compressed state to the expanded state, thereby filling the airbag 10.

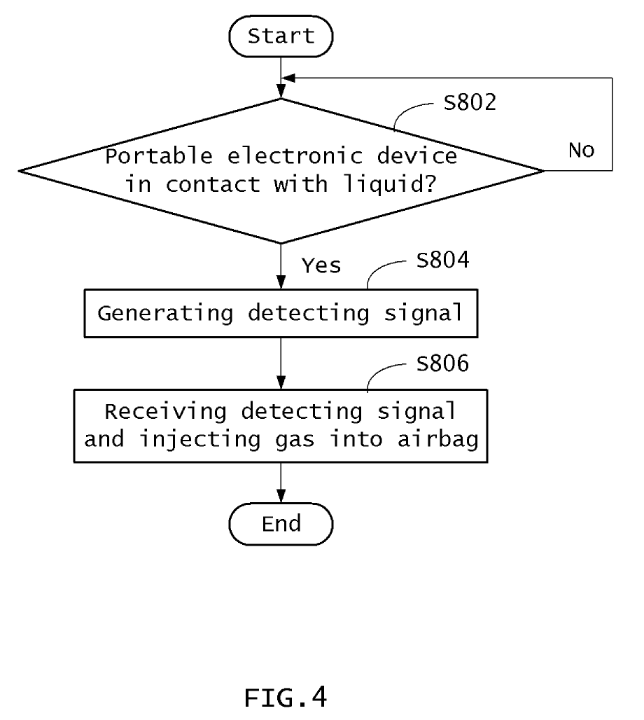

Referring to FIG. 4, a flowchart of a recovery method for a portable electronic device in accordance with an exemplary embodiment is shown. The recovery method may be implemented using the portable electronic device 100 (FIG. 1). The recovery method includes the following blocks:

Beginning in block S802, it is determined whether the portable electronic device 100 is in contact with liquid. If the portable electronic device 100 is in contact with liquid, the procedure goes to block S804. If the portable electronic device 100 is not in contact with liquid, the procedure returns to block S802.

In block S804, a detecting signal is generated.

In block S806, the detecting signal is received, and the gas-injection apparatus 50 is controlled to inject gas into the airbag 10, so that the airbag 10 becomes inflated and enables the portable electronic device 100 to float. Thereby, the airbag 10 helps protect the portable electronic device 100 from liquid (e.g. water) damage, and enables the portable electronic device 100 to be conveniently recovered.

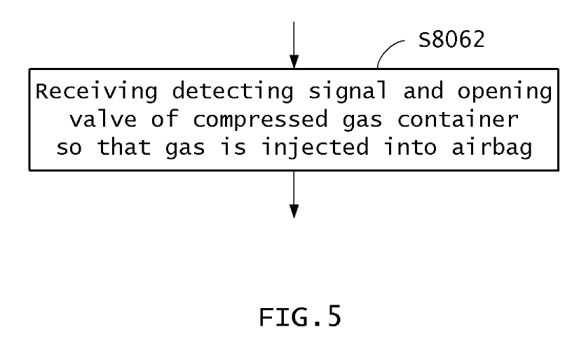

Referring to FIG. 5, in one embodiment, block S806 may include the following block:

In block S8062, the detecting signal is received, and the valve 24 of the gas-injection apparatus 20 is opened, so that gas in the compressed gas container 22 is injected into the airbag 10.

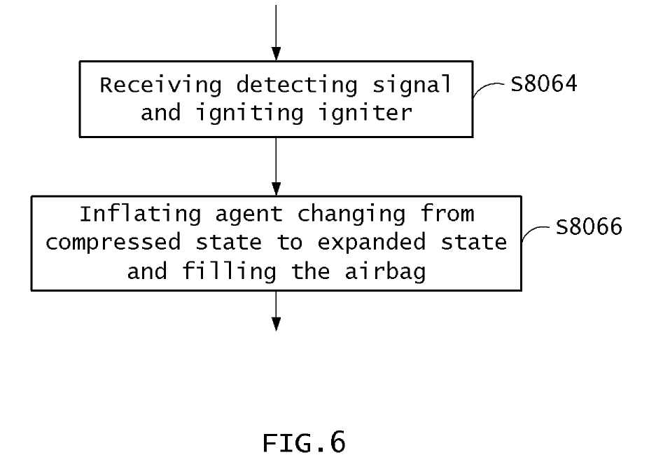

Referring to FIG. 6, in another embodiment, the block S806 may include the following blocks:

In block S8064, the detecting signal is received, and the igniter 26 is ignited.

In block S8066, the inflating agent 28 changes from the compressed state to the expanded state, thereby filling the airbag 10 with gas.

It is to be understood, however, that even though numerous information and advantages of the present embodiments have been set forth in the foregoing description, together with details of the structures and functions of the embodiments, the disclosure is illustrative only, and that changes may be made in detail, especially in matters of shape, size, and arrangement of parts within the principles of the present disclosure to the full extent indicated by the broad general meaning of the terms in which the appended claims are expressed.

What is claimed is:

1. A portable electronic device comprising:
an airbag;
a gas-injection apparatus connected with the airbag for injecting gas into the airbag so that the airbag is in an inflated state;
a housing with a receiving space accommodating the airbag in a deflated state, wherein the airbag is capable of expanding out of the housing when changing from the deflated state to the inflated state;
a liquid detecting apparatus configured for detecting when the portable electronic device is in contact with liquid and generating a detecting signal; and
a control apparatus configured for controlling the gas-injection apparatus to inject gas into the airbag upon receiving the detecting signal.

2. The portable electronic device according to claim 1, wherein the liquid detecting apparatus comprises a liquid sensor.

3. The portable electronic device according to claim 1, wherein the gas-injection apparatus comprises a compressed gas container and a valve; and the control apparatus is capable of opening the valve so that gas in the compressed gas container is injected into the airbag upon receiving the detecting signal.

4. The portable electronic device according to claim 1, wherein the gas-injection apparatus comprises an igniter and an inflating agent; the inflating agent is capable of selectively existing in one of a compressed state and an expanded state; the compressed state is one of a liquid form and a solid form, and the expanded state is a gaseous form; the inflating agent changes from the compressed state to the expanded state when ignited; and the control apparatus is capable of controlling the igniter to ignite so that the inflating agent changes from the compressed state to the expanded state and fills the airbag with gas upon receiving the detecting signal.

5. The portable electronic device according to claim 1, wherein the housing comprises a lid for covering the receiving space; and the airbag is capable of breaking out of the lid when changing from the deflated state to the inflated state.

6. A recovery method for a portable electronic device comprising:
determining whether the portable electronic device is in contact with liquid;
generating a detecting signal if the portable electronic device is determined as being in contact with liquid; and
receiving the detecting signal and controlling a gas-injection apparatus to inject gas into an airbag of the portable electronic device.

7. The recovery method according to claim 6, further comprising:
returning to determining whether the portable electronic device is in contact with liquid if the portable electronic device is determined as not being in contact with liquid.

8. The recovery method according to claim 6, wherein controlling the gas-injection apparatus to inject gas into the airbag comprises opening a valve of a compressed gas container so that gas in the compressed gas container is injected into the airbag.

9. The recovery method according to claim 6, wherein controlling the gas-injection apparatus to inject gas into the airbag comprises:
igniting an igniter; and
an inflating agent changing from a compressed state to an expanded state and filling the airbag.

10. The recovery method according to claim 9, wherein the inflating agent in the expanded state is in a gaseous form.

11. A recovery method for a portable electronic device comprising:
determining whether the portable electronic device is in contact with liquid;
generating a detecting signal if the portable electronic device is determined as being in contact with liquid; and
receiving the detecting signal and igniting an igniter; and
an inflating agent changing from a compressed state to an expanded state and filling the airbag.

12. The recovery method according to claim 11, wherein the inflating agent in the expanded state is in a gaseous form.
